(19) United States
(12) Patent Application Publication
(10) Pub. No.: US 2009/0059432 A1
(43) Pub. Date: Mar. 5, 2009

(54) HEAD SLIDER OF MAGNETIC DISK DEVICE

(75) Inventors: Hiroyuki Kubotera, Kawasaki (JP); Naozumi Tsuda, Kawasaki (JP); Takahiro Imamura, Kawasaki (JP); Toru Watanabe, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/103,940

(22) Filed: Apr. 16, 2008

(30) Foreign Application Priority Data
Aug. 31, 2007 (JP) 2007-226896
Oct. 30, 2007 (JP) 2007-282005

(51) Int. Cl. G11B 5/60

(52) U.S. Cl. 360/236.6; 360/235.4

(57) ABSTRACT

Lubricant on a rotating recording medium can attach to a slider, particularly on the pad formed in the proximity of the trailing edge. In the slider of this invention, lubricant is not accumulated in the vicinity of the trailing edge and can be drawn to the trailing edge and dispersed constantly. The head slider includes a center pad formed on an air bearing surface in the vicinity of the center of a trailing edge of the slider. A trailing pad is formed so as to bridge a trailing edge of the center pad and the trailing edge of the slider. The trailing pad is formed lower than a highest surface of the center pad and higher than a lowest surface of the slider.

### BACKGROUND OF THE INVENTION

1. Field of the Invention

This invention relates to a head slider of a magnetic disk device.

2. Description of the Related Art

Recently, to achieve higher recording density, magnetic disk devices have reduced spacing between a read/write head and a recording medium (a magnetic disk or a medium), in other words, a magnetic spacing. To achieve this, it is required to reduce a flying height of a slider having a read/write head, in other words, a head slider. Nowadays, the flying height of the head slider is less than 10 nm. With the reduction of the flying height of the head slider, the probability that lubricant on the medium will attach to the head slider increases.

FIG. 1 is a perspective view of a conventional head slider viewed from a surface opposed to the medium. FIG. 2 is a plan view of the surface opposed to the medium shown in FIG. 1. A surface can refer to a side, a surface on a side or a plurality of surfaces. The side of the head slider placed adjacent the rotary medium (the magnetic disk or the magnetic recording medium) has a leading pad 102, two side rails 104A and 104B and a center pad 106, i.e., an air bearing surface, for generating airflow between the medium and the slider to induce positive and negative pressures against the medium.

The conventional head slider shown in FIG. 1 has a clearance 110 between the center pad 106 and a trailing edge 108 (the edge of the slider around from which the air outflows) of the slider. (Refer to Japanese Laid-open Patent Publication 2005-293701). For another conventional head slider, the center pad is surrounded with a surface that is one step lower than the highest surface (called a step surface).

Where the lubricant coated on the medium attaches on the slider for any reason, the attached lubricant flows over the slider due to airflow and then gathers on the clearance 110 formed between the center pad 106 and a trailing edge 108 as a liquid drop 212 as shown in FIG. 2. The droplet 212 is apt to affect the slider flying height characteristics. Further, if the lubricant gathers until it grows to a big enough droplet, it will fall on the medium from the slider as a mass. If the slider then touches the lubricant drop, flying becomes unstable, in the worst case causing a crash. The lubricant is also apt to become accumulated on the above-mentioned step surface.

FIG. 3 is a perspective view of the other conventional head slider viewed from the opposed surface to the medium. FIG. 4 to FIG. 6 are plan views of the conventional head slider shown in FIG. 3 viewed from the surface opposed to the medium. As shown in FIG. 3 and FIG. 4, this head slider has a rail 332 formed so as to surround a part (area) to generate the negative pressure, in other words, a negative pressure part (a negative pressure area) 330. As shown in FIG. 5, lubricant 540 attaches on the rail indicated with a thick line. Then the lubricant 540 flows over a slider flying surface, and then, on the flying surface in the vicinity of the trailing edge or on the edge face of the trailing edge, an area 642 where the lubricant collected appears. Where the gathered lubricant grows to an unacceptably big droplet, it falls from the slider to the medium in a mass. Thereafter, if the slider touches the lubricant drop, the collision makes flying of the slider unstable, and in the worst case, causes a crash. The slider can fly higher over the lubricant drop, even in that case the magnetic spacing increases and data reading/writing is impinged.

Since the rail formed to surround the negative pressure parts stretches substantially across the slider in the width direction, the lubricant is apt to be accumulated between the center pad and the both sides of the slider rather than in the vicinity of the center pad where the lubricant attaching on the rail indicated with the thick line flows to the trailing edge. Further, where the lubricant flows to the edge face of the trailing edge, it is apt to be distributed in the vicinity of both sides of the slider rather than in the vicinity of the center pad. Consequently, the lubricant is not easily vaporized by a heating mechanism buried in the neighborhood of the center pad.

The head slider of this invention is presented in terms of the problems described above. One of the aims of this invention is to provide a slider in which lubricant attaching on the slider, particularly on the pad formed in the proximity of the trailing edge, does not accumulate in the vicinity of the trailing edge, yet can be drawn to the trailing edge constantly. Another aim of this invention is to provide a slider that facilitates spread and vaporization of the lubricant attaching on the slider surface in order to prevent unstable flying attributed to lubricant that is dropped on the medium. Another aim of this invention is to provide a head slider that reduces the attachment of the lubricant of the medium on the slider surface by surrounding the center pad with the step surface.

Further, another aim of this invention is to provide a head slider that prevents the attachment of the lubricant on the rail surrounding the negative pressure parts for generating the negative pressure on the slider flying surface and is less apt to accumulate the lubricant on the part where the lubricant is hard to vaporize by the heating mechanism.

### SUMMARY

In accordance with an aspect of an embodiment, a head slider of a magnetic disk device having a recording medium includes a center pad formed on an air bearing surface in the vicinity of the center of a trailing edge of the slider. A trailing pad is formed so as to bridge a trailing edge of the center pad and the trailing edge of the slider and is formed lower than a highest surface of the center pad and higher than a lowest surface of the slider. The head slider is designed not to have surfaces in the same height of the trailing edge pad on both sides of the center pad in a width direction.

### BRIEF DESCRIPTION OF THE DRAWINGS

FIG. 1 is a perspective view of a conventional head slider showing a side or surface opposed to the medium.

FIG. 2 is a plan view of the head slider shown in FIG. 1, viewed from the surface opposed to the medium.

FIG. 3 is a perspective view of another conventional head slider, showing a surface opposed to the medium.

FIG. 4 is a plan view of the head slider shown in FIG. 3, viewed from the surface opposed to the medium.

FIG. 5 is the same plan view of FIG. 4, showing the lubricant attaching on the rail.

FIG. 6 is the same plan view of FIG. 4, showing the lubricant accumulation.

FIG. 7 illustrates a schematic structure of a magnetic disk device applying the head slider of this invention.

FIG. 8 is a perspective view of a head slider in a first embodiment of this invention, showing a side or surface opposed to the medium.

FIG. 9 is a plan view of the head slider shown in FIG. 8, viewed from the surface opposed to the medium.

FIG. 10 is a perspective view of a head slider in a second embodiment of this invention, showing the surface opposed to the medium.

FIG. 11 is a perspective view of a head slider in a third embodiment of this invention, showing the surface opposed to the medium.

FIG. 12 is a perspective view of a trailing edge pad of a head slider in a fourth embodiment of this invention.

FIG. 13 is a perspective view of a trailing edge pad of a head slider in a fifth embodiment of this invention.

FIG. 14 is a perspective view of a head slider in a sixth embodiment of this invention, showing the surface opposed to the medium.

FIG. 15 is a perspective view of a head slider in a seventh embodiment of this invention, showing the surface opposed to the medium.

FIG. 16 is a perspective view of a head slider in an eighth embodiment of this invention, showing the surface opposed to the medium.

FIG. 17 is a perspective view of a head slider in a ninth embodiment of this invention, showing the surface opposed to the medium.

FIG. 18 is a perspective view of a head slider in a tenth embodiment of this invention, showing the surface opposed to the medium.

FIG. 19 is a perspective view of a head slider in an eleventh embodiment of this invention, showing the surface opposed to the medium.

FIG. 20 is a perspective view of a head slider in a twelfth embodiment of this invention, showing the surface opposed to the medium.

FIG. 21 is a perspective view of a head slider in a thirteenth embodiment of this invention, showing the surface opposed to the medium.

FIG. 22 is a perspective view of a head slider in a fourteenth embodiment of this invention, showing the surface opposed to the medium.

FIG. 23 is a perspective view of a head slider in a fifteenth embodiment of this invention, showing the surface opposed to the medium.

FIG. 24 is a plan view of the head slider shown in FIG. 23, viewed from the surface opposed to the medium.

FIG. 25 is the same plan view of FIG. 24, showing the rail on which the lubricant does not attach.

FIG. 26 is the same plan view of FIG. 24, showing that the lubricant does not accumulate.

FIG. 27 is a perspective view of a head slider in a sixteenth embodiment of this invention, showing the surface opposed to the medium.

FIG. 28 is a plan view of the opposed surface of the head slider shown in FIG. 27.

FIG. 29 is a perspective view of a head slider in a seventeenth embodiment of this invention, showing the surface opposed to the medium.

FIG. 30 is a plan view of the opposed surface of the head slider shown in FIG. 29.

FIG. 31 is a perspective view of a head slider in an eighteenth embodiment of this invention, showing the surface opposed to the medium.

### DETAILED DESCRIPTION OF THE EMBODIMENTS

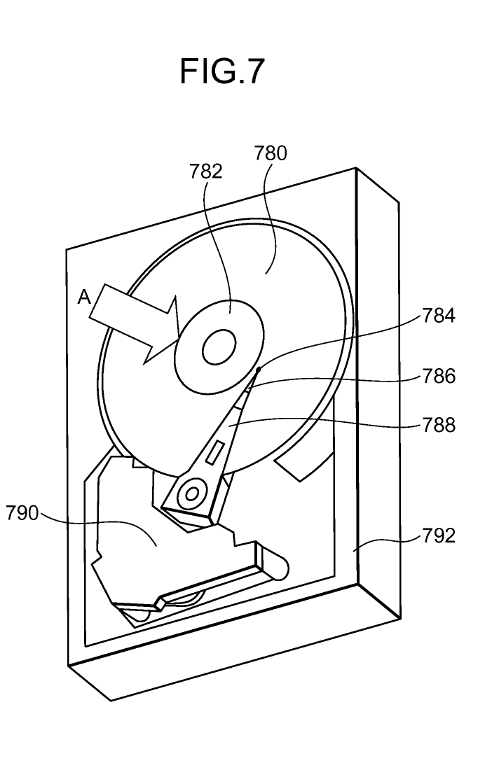

Referring to FIG. 7, the schematic structure of a magnetic disk device applying the head slider of this invention will be discussed. The magnetic disk device is a sort of recording device having the head slider mounted with a read/write head for reading/writing data by tracking over a rotary recording medium. For convenience sake, a cover attached from a direction indicated with an arrow A is removed.

As shown in FIG. 7, the magnetic recording medium (the magnetic disk or the medium) 780 is clamped with a clamp 782 on a spindle motor. The magnetic recording medium rotates at the predetermined revolving speed by the spindle motor. The head slider 784 tracks above the magnetic recording medium from a distance on the nano scale. The read/write head mounted on the head slider operates from a certain spacing above the magnetic recording medium 780. The slider 784 is attached to a drive arm 788 with a suspension 786 applying a certain pressure to the slider 784. Data is read from or written on a desired position on the magnetic recording medium 780 by tracking with the read/write head attached to the drive arm 788 that is driven by a voice coil motor 790. These components are attached on a base 792.

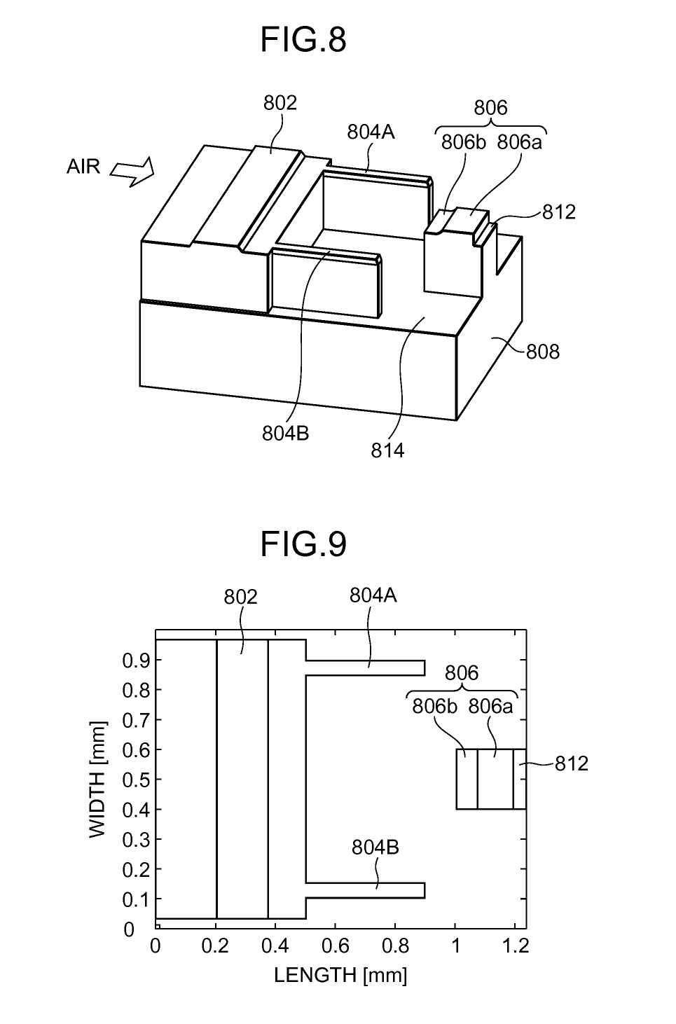

Referring to the figures attached, embodiments of this invention will be discussed. FIG. 8 is a perspective view of the head slider in the first embodiment of this invention, viewed from the opposed surface (air bearing surface) to the medium. FIG. 9 is a plan view of the opposed surface of the head slider shown in FIG. 8. The slider body is made of alumina titanium carbide (Al—Ti—C) and the air trailing edge part on which the read/write head is formed is made of alumina and by the conventional methods such as ion milling or ion etching.

The flow of the lubricant on the slider basically corresponds to the shearing force vector of the air film. There are two factors to generate the shearing force of the air film: one is the Couette flow that is caused by circumferential velocity of the medium, the other is the Poiseuille flow that flows from a high air film pressure area to a low air film pressure area.

In the vicinity of the trailing edge of the slider (the edge where air outflows), these two elements are equal. As a consequence, the lubricant is apt to be accumulated there. The head slider shown in FIG. 8 has pads formed on the area where the lubricant is apt to be collected, thereby increasing the Couette flow component of the air film shearing force, preventing the concentration of the air film shearing force.

In FIG. 8, a reference character 802 denotes a leading pad formed on the leading edge (the edge where the air flows). Reference characters 804A and 804B denote side rails stretching from the leading pad 802 in the airflow direction. A reference character 806 denotes a center pad formed near the center of a trailing edge 808. A reference character 812 denotes a trailing edge pad integrated with the center pad 806, characterizing an aspect of this invention.

This trailing pad 812 is formed so as to bridge between the trailing edge of the center pad 806 and the trailing edge 808 of the slider. The trailing edge pad 812 is lower than a surface 806a that is the highest surface of the center pad 806 and higher than a surface 814 that is the lowest surface of the slider. The head slider shown in FIG. 8 is designed to not have surfaces in the same height of the trailing edge pad 812 on both sides of the center pad 806.

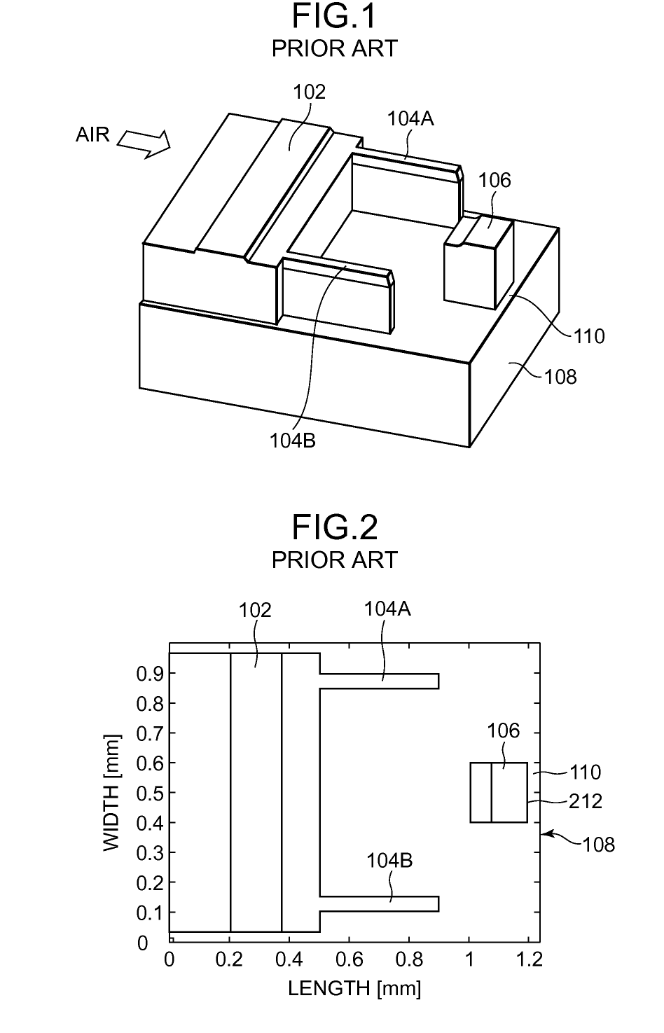

For the head slider shown in FIG. 8, there is no clearance such as the clearance 110 shown in FIG. 1, viz, the area where the lubricant is apt to be collected is removed. Hence, the lubricant draws toward the trailing edge constantly before it grows to a mass. Differently from FIG. 2, FIG. 9 shows that the lubricant droplet is not generated. In this manner, the problem of the conventional technique in which the lubricant mass affects on the flying characteristics is solved.

For the head slider shown in FIG. 8, the center pad 806 is not surrounded by the step surface 806b (the surface that is one step lower than the highest surface 806a). Thus the attachment of the lubricant of the medium on the slider surface is reduced.

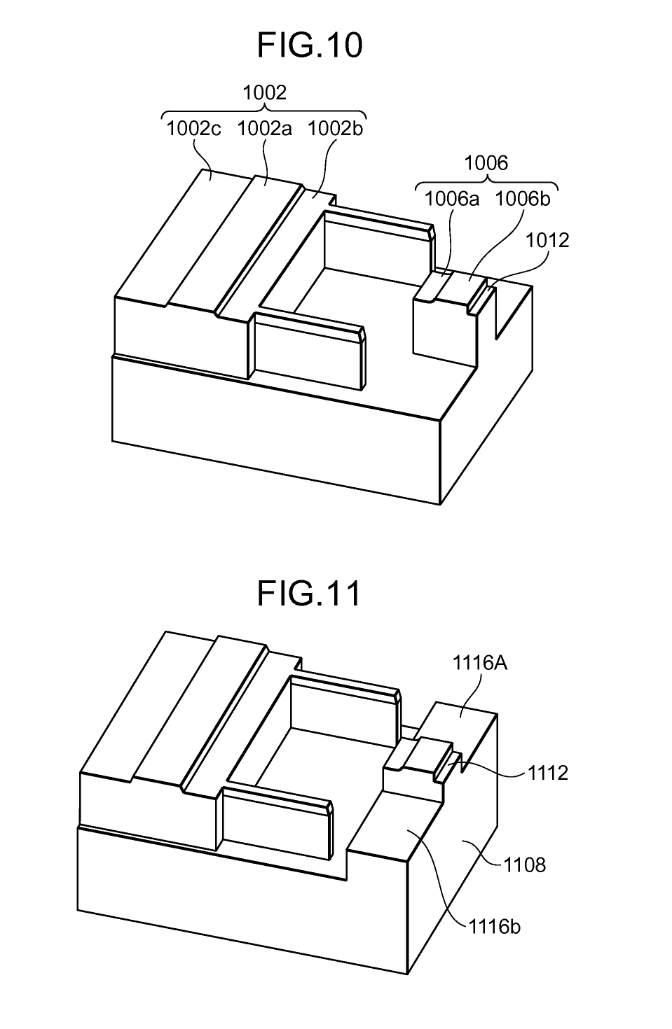

FIG. 10 is a perspective view of the head slider in the second embodiment of this invention, viewed from the surface opposed to the medium. In FIG. 10, reference characters 1002, 1002a, 1002b/1002c denote the leading pad, the highest surface of the leading pad 1002 and the step surfaces (the surfaces that are one step lower than 1002a) of the leading pad 1002, respectively. Reference characters 1006, 1006a and 1006b denote the center pad, the highest surface of the center pad 1006, and the step surfaces (the surfaces that are one step lower than 1006a) of the center pad 1006, respectively. A reference character 1012 denotes the trailing edge pad.

On the head slider shown in FIG. 10, the heights of the trailing pad 1012 and the surface 1006b that is formed on the leading side of the center pad 1006 are substantially the same. Even forming the trailing edge pad 1012 in that height, the lubricant can flow off, which also makes the fabrication of the head slider easier. Again, by forming the step surfaces 1002b and 1002c of the leading pad 1012 in the same height as the trailing edge pad 1012 and the step surface 1006b of the center pad, the effect increases. Specifically, the trailing edge pad 1012 can be 0.1 μm lower than the highest surface 1006b of the center pad 1006 or lower.

FIG. 11 is a perspective view of the head slider in the third embodiment of this invention viewed from the surface opposed to the medium. For this head slider, the pads 1116A and 1116b that are lower than a trailing edge pad 1112 are formed on the trailing edge 1108 of the slider, thereby preventing lubricant accumulation near the trailing edge 1108.

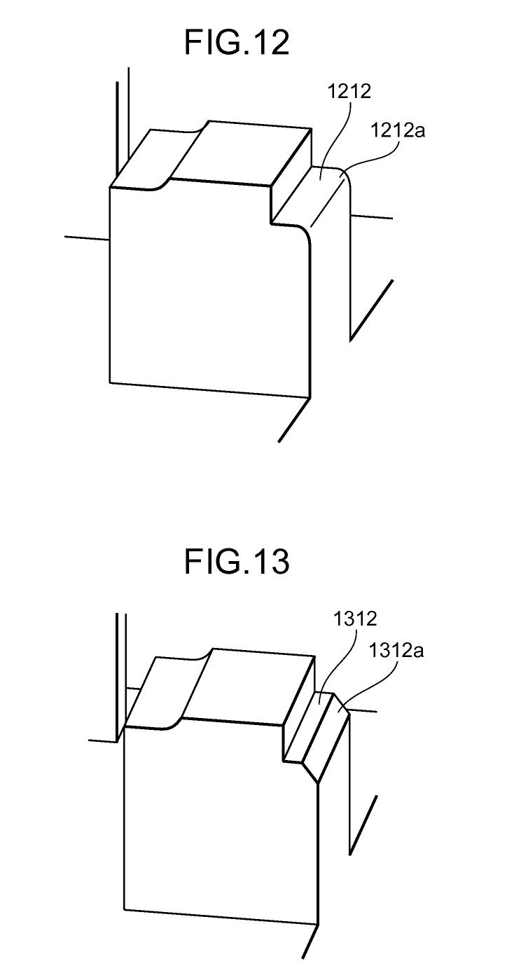

FIG. 12 is a perspective view of the trailing edge pad of the head slider in the fourth embodiment of this invention. For the head slider shown in FIG. 12, a corner 1212a of the trailing edge pad 1212 is rounded. Therefore the lubricant can flow off more easily.

FIG. 13 is a perspective view of the trailing edge pad of the head slider in the fifth embodiment of this invention. For the head slider shown in FIG. 13, a corner 1312a of the trailing edge pad 1312 is chamfered, thereby obtain the same effect that the lubricant can flow off easily as in the embodiment shown in FIG. 12. Further, it makes the fabrication of the head slider easier than in the embodiment shown in FIG. 12.

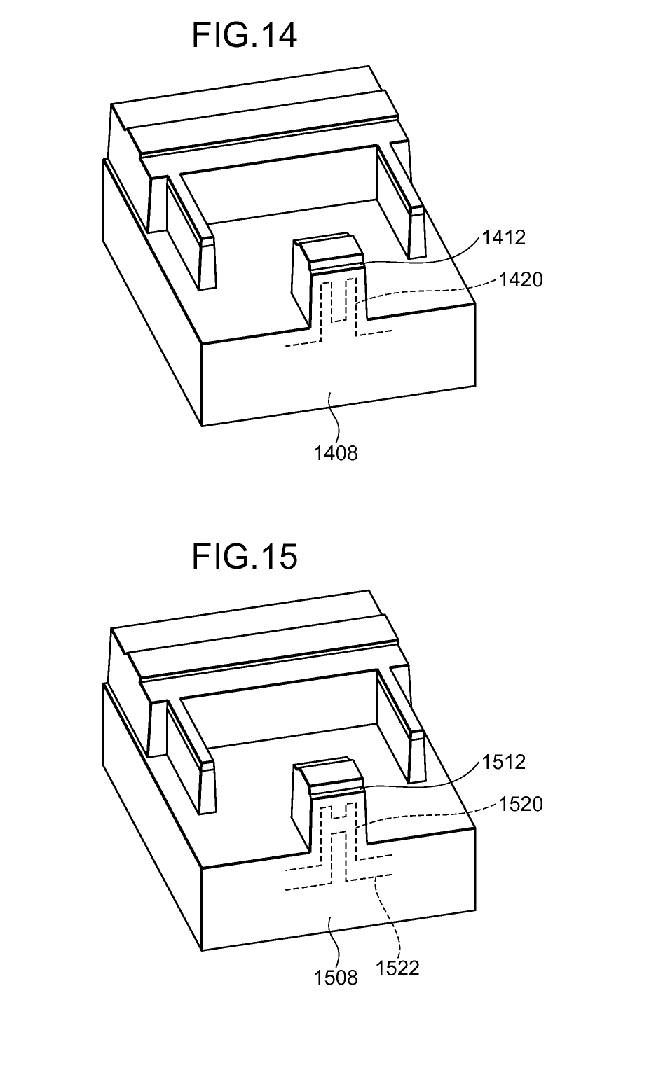

FIG. 14 is a perspective view of the head slider in the sixth embodiment of this invention, viewed from the surface opposed to the medium. As shown in FIG. 14, a trailing edge of the trailing edge pad 1412 is integrated with a slider trailing edge 1408. In the slider trailing edge 1408, a heating wire is buried as a heating mechanism 1420 for flying height control. This heating mechanism 1420 for flying height control accomplishes a function to lower the flying height of the slider from the medium surface by expanding itself by electricity conduction, vaporizing the lubricant drawn to the slider trailing edge.

In order to vaporize the lubricant, the heating mechanism 1420 for flying height control is activated after data reading/writing during which time the probability of the lubricant attachment is high. For the same reason, the heating mechanism 1420 for flying height control is also activated when the head contacts the medium. Further, it is preferable that the heating mechanism 1420 for flying height control be fed a weak current to facilitate the vaporization of the lubricant after applying the certain amount of current. Again, it is also preferable to apply current to the heating mechanism 1420 for flying height control after the slider has tracked the medium for a certain period of time from above a certain magnetic spacing to reduce the probability of lubricant attachment.

FIG. 15 is a perspective view of the head slider in the seventh embodiment of this invention, viewed from the surface opposed to the medium. Like the head slider shown in FIG. 14, the head slider shown in FIG. 15 has the heating mechanism 1520 for flying height control. In addition, a heating mechanism 1522 for lubricant vaporization is buried in an edge face of the slider trailing edge 1508 (including a trailing edge of the trailing edge pad 1512). The heating mechanism 1522 for lubricant vaporization is formed for an exclusive use of the lubricant vaporization, and is activated under the same conditions of the heating mechanism for flying height control shown in FIG. 14. It is acceptable to form only the heating mechanism for lubricant vaporization without forming the heating mechanism for flying height control.

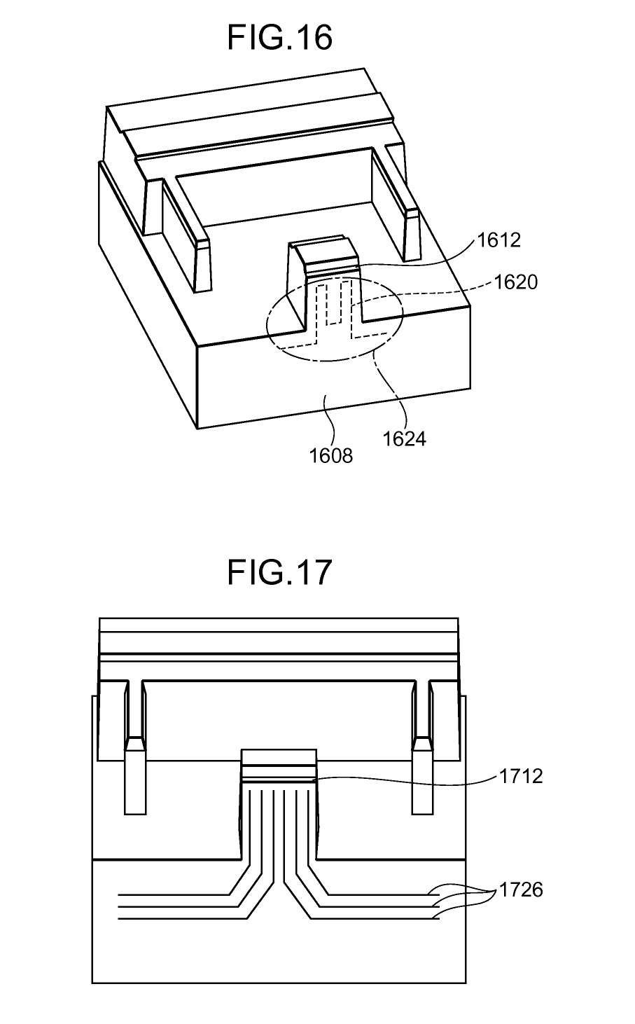

FIG. 16 is a perspective view of the head slider in the eighth embodiment of this invention, viewed from the surface opposed to the medium. For the head slider shown in FIG. 16, a portion around a heating mechanism 1620 buried in a trailing edge 1608 (including a trailing edge of the trailing edge pad 1612), in other words (the area indicated with a reference character 1624) is made of a material that is more conductive than alumina. Therefore, heat can be readily conducted from the heating mechanism 1620 to the trailing edge 1608. As a result, the lubricant vaporizes efficiently. The heating mechanism 1620 is the heating mechanism for flying height control and/or the heating mechanism for lubricant vaporization.

FIG. 17 is a perspective view of the head slider in the ninth embodiment of this invention, viewed from the surface opposed to the medium. For the head slider shown in FIG. 17, grooves 1726 are formed in a depth of several microns—(for example, 0.5-200 μm, preferably, 3-50 μm) on an edge face of a slider trailing edge 1708 (including a trailing edge of a trailing edge pad 1712). Owing to the capillary phenomenon attributed to the grooves 1726, the lubricant drawn to the slider trailing edge can spread and vaporize more efficiently. As a result, the lubricant drop is prevented and the flying stability of the head slider is improved.

In FIG. 17, the grooves 1726 stretch from the trailing edge pad 1712 to both sides of the slider. By stretching the grooves to both sides of the slider, the lubricant is drawn across the edge face.

The grooves 1726 shown in FIG. 17 are not formed not to extend to a flying surface (the surface opposed to the medium) of the trailing edge pad 1712. If the grooves 1726 were to stretch to the flying surface of the trailing edge pad 1712, a corner should be formed, which makes the fabrication of the head slider difficult and increases the probability that the head will break if it contacts the medium.

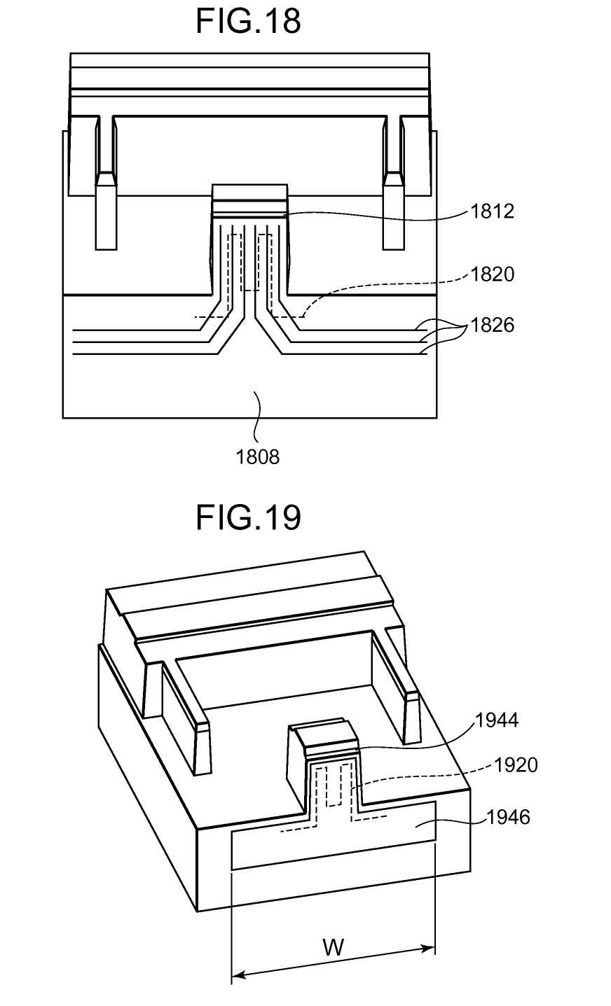

FIG. 18 is a perspective view of the head slider in the tenth embodiment of this invention, viewed from the surface opposed to the medium. For the head slider shown in FIG. 18, on the edge face of the slider trailing edge 1808 (including a trailing edge of the trailing edge pad 1812), the aforementioned grooves 1826 are formed and a heating mechanism 1820 for flying height control is buried therein.

On the head slider shown in FIG. 18, when the temperature rises due to the heating mechanism 1820 for flying height control, a fluidity of the lubricant increases. Thus the lubricant can be drawn to the grooves 1826 easily. Because of the large superficial dimension of the grooves 1826, the lubricant drawn to the grooves 1826 can be easily vaporized.

In all embodiments described above, it is preferable that the edge face of the slider trailing edge be made of a material having a higher surface free energy than the free energies of the lubricant and alumina. For instance, the edge face can be made of a carbon film or a metal film as the material having a high surface free energy.

FIG. 19 is a perspective view of the head slider in the eleventh embodiment of this invention, viewed from the surface opposed to the medium. In FIG. 19, reference characters 1944, 1920 and 1946 denote a part where the read/write head is formed, the heating mechanism for flying height control and a heat transfer plate, respectively. For the head slider shown in FIG. 19, the center of the air bearing surface (the part 1944 where the read/write head is formed) is nearest to the medium during operation, so the lubricant is apt to be accumulated thereon. For this reason, a width W of the heat transfer plate 1946 is specified to be equal to the width of the air bearing surface of the center pad or wider, and the area where the heat transfer plate 1946 is buried is heated to vaporize the lubricant. The width W of the heat transfer plate 1946 is specified to be less than the width of the slider. As described above, in this embodiment, the heat transfer plate is buried in the edge face to increase the effect of the heating mechanism, thereby heating the lubricant in a wider range.

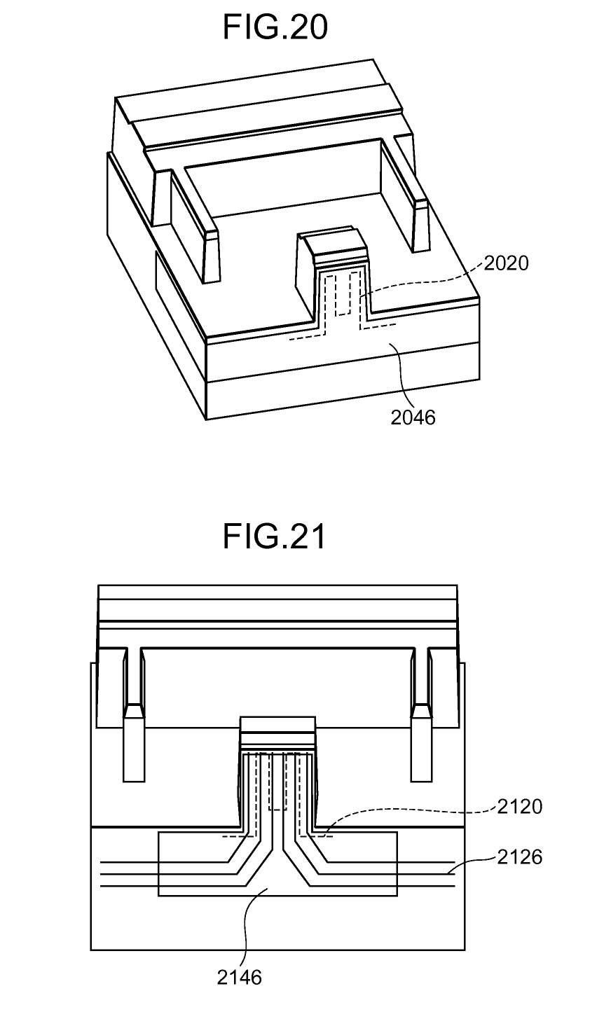

FIG. 20 is a perspective view of the head slider in the twelfth embodiment of this invention, viewed from the surface opposed to the medium. Likewise the head slider shown in FIG. 19, the head slider shown in FIG. 20 has a heating mechanism 2020 and a heat transfer plate 2046. However, the head slider shown in FIG. 20 differs from the head slider shown in FIG. 19 in that its heat transfer plate 2046 extends to the lateral faces of the slider to vaporize the lubricant accumulated thereon.

FIG. 21 is a perspective view of the head slider in the thirteenth embodiment of this invention, viewed from the surface opposed to the medium. Like the head slider shown in FIG. 19, the head slider shown in FIG. 21 has a heating mechanism 2120 and a heat transfer plate 2146. In addition, grooves 2126 are formed on the center pad which is part of the air bearing surface. Due to the capillary phenomenon of the grooves 2126, the lubricant accumulated on the trailing edge of the center pad is drawn in the width direction of the slider. Thus, the lubricant accumulated on the trailing edge of the center pad is widely spread and facilitated to be vaporized. Additionally, the heating effect by the heat transfer plate 2146 further facilitates the vaporization of the lubricant. In this embodiment, the width of the heat transfer plate 2146 is substantially the same as the width of the slider.

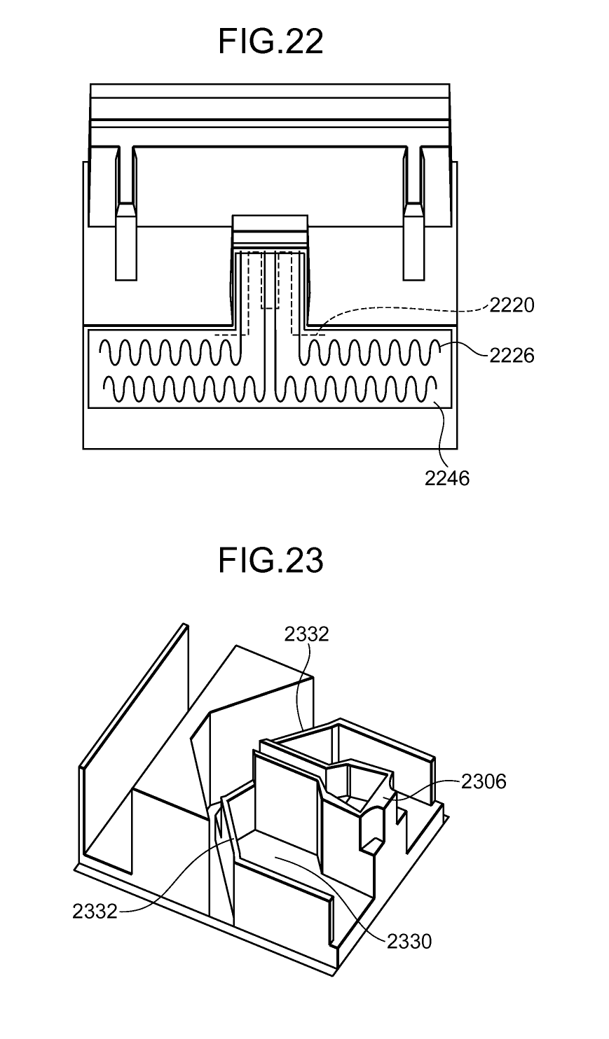

FIG. 22 is a perspective view of the head slider in the fourteenth embodiment of this invention, viewed from the surface opposed to the medium. Like the head slider shown in FIG. 21, the head slider shown in FIG. 22 has a heating mechanism 2220, a heat transfer plate 2246 and grooves 2226. However, the head slider shown in FIG. 22 differs from the head slider shown in FIG. 21 in that its grooves 2226 are formed in a meander shape to lengthen its length. Owing to the meander shape, the amount of the lubricant per unit area is reduced, so the lubricant can be vaporized more efficiently. For the head sliders shown in FIG. 17 and FIG. 18, their grooves can be meandered as in FIG. 22.

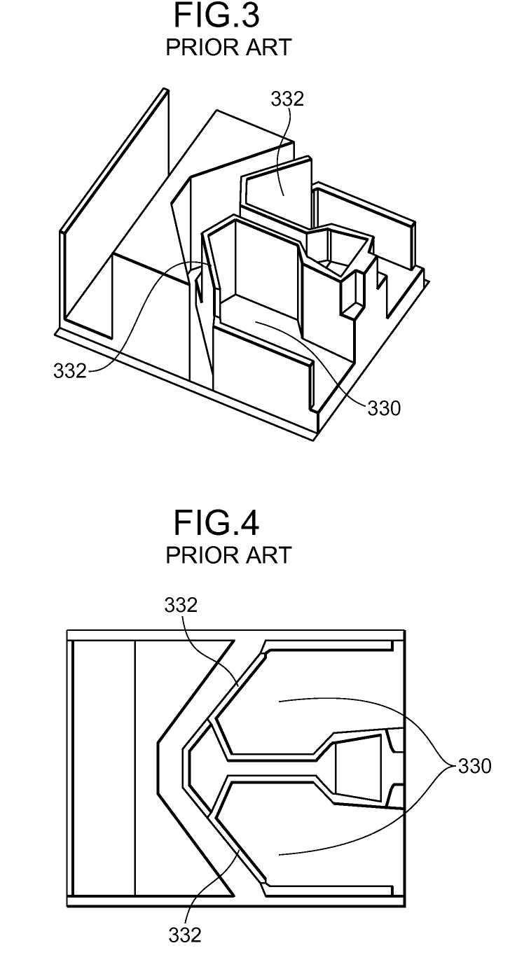

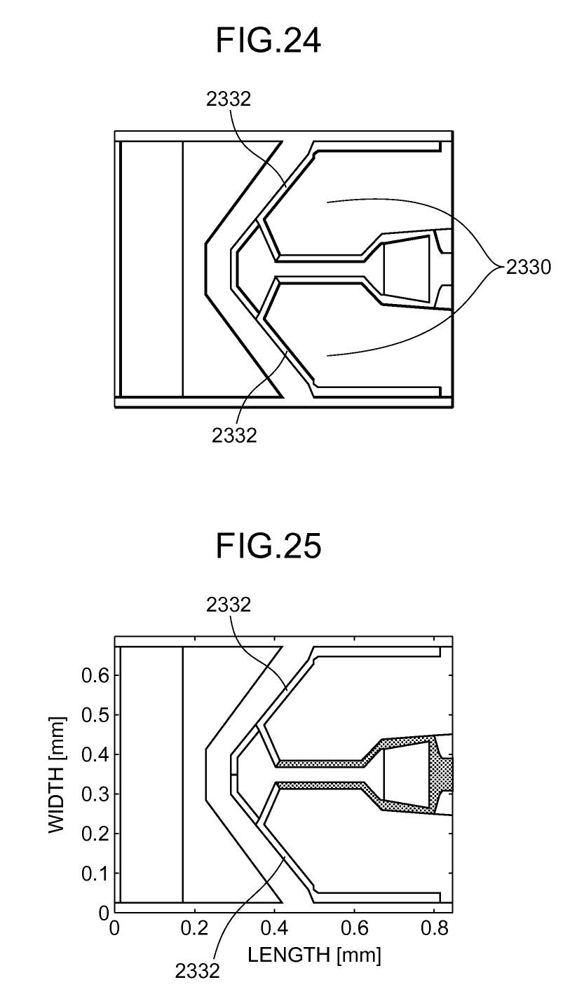

FIG. 23 is a perspective view of the head slider in the fifteenth embodiment of this invention, viewed from the surface opposed to the medium. FIGS. 24, 25 and 26 are plan views of the head slider shown in FIG. 23. This embodiment corresponds to the conventional head slider shown in FIG. 3-6. For the head slider shown in FIG. 23 and FIG. 24, rails 2332 are formed and stretch in the width direction so as to surround negative pressure areas 2330. The rails 2332 are 0.1 μm lower than the highest surface of the slider (the surface indicated with a reference character 2306) or lower.

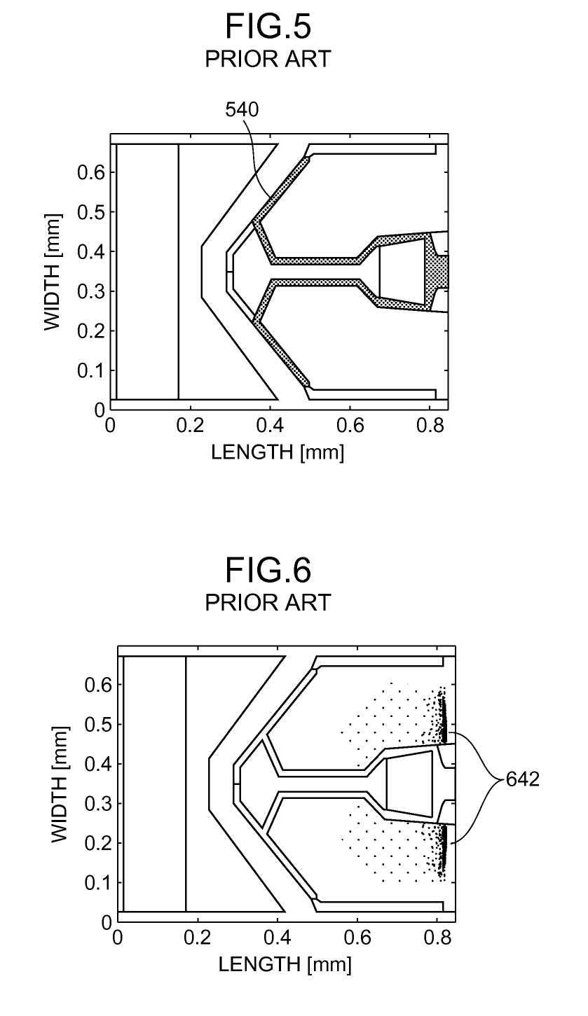

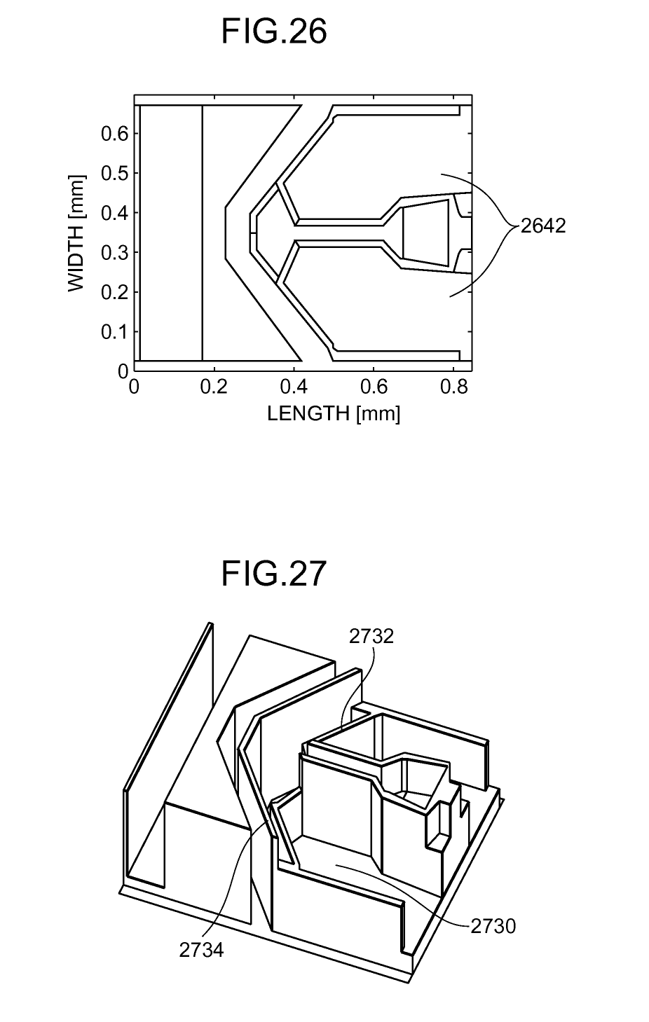

Owing to the height of the rails formed in the width direction so as to surround the negative pressure areas, a spacing between the rails and the medium increases. As a result, unlike the case show in FIG. 5, the lubricant on the medium is not likely to attach on the rails 2332. As a consequence, unlike the case shown in FIG. 6, the lubricant does not accumulate in the vicinity of the trailing edge (as indicated with a reference character 2642 in FIG. 26) when the lubricant flows. Therefore, the probabilities of a lubricant drop phenomenon, instability of flying, a crash, of the data reading/writing characteristics decrease, and stable flying characteristics in ultra-low flying can be achieved.

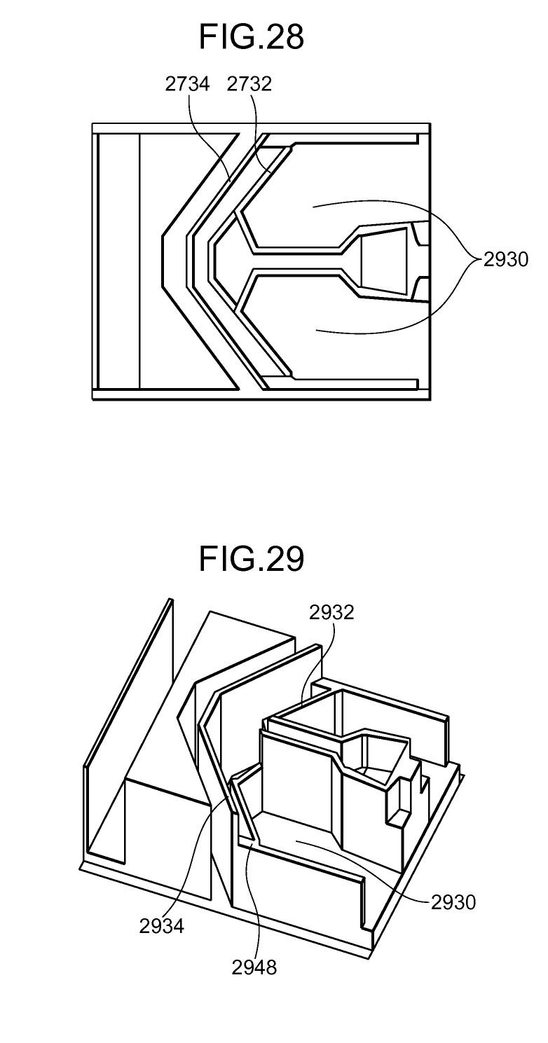

FIG. 27 is a perspective view of the head slider in the sixteenth embodiment of this invention, viewed from the surface opposed to the medium. FIG. 28 is a plan view of the opposed surface of the head slider shown in FIG. 27. The sixteenth embodiment is a variation of the fifteenth embodiment. In FIG. 27 and FIG. 28, reference characters 2732 and 2734 denote a plurality of rails formed to surround double negative pressure areas 2730 The single rail 2732 can be formed 0.1 μm lower than the highest surface or lower.

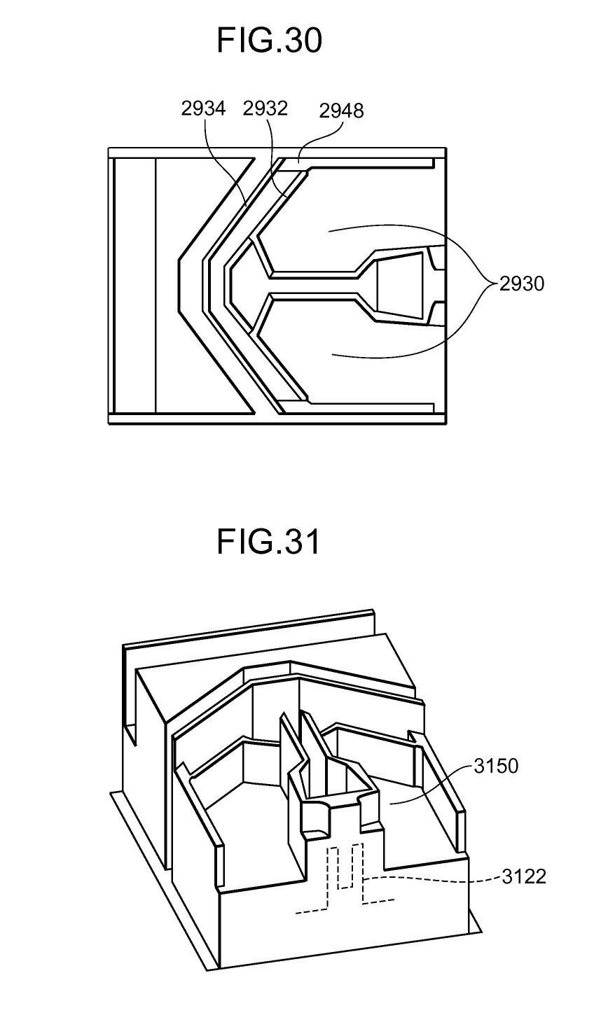

FIG. 29 is a perspective view of the head slider in the seventeenth embodiment of this invention, viewed from the surface opposed to the medium. FIG. 30 is a plan view of the opposed surface of the head slider shown in FIG. 29. The seventeenth embodiment is similar to the sixteenth embodiment described above. In FIG. 29 and FIG. 30, reference characters 2932 and 2934 denote a plurality of rails formed to surround double negative pressure areas 2930. Of the rails, a rail 2932 is an inside rail, 0.1 μm lower than the highest surface or lower. A rail 2934 is an outside rail, 0.1 μm lower than the highest surface or lower. A reference character 2948 denotes a rail bridging the inside rail 2932 and the outside rail 2934, stretching in a longitudinal direction of the slider.

FIG. 31 is a perspective view of the head slider in the eighteenth embodiment of this invention, viewed from the surface opposed to the medium. The eighteenth embodiment has more characteristics added to the 15-17^{t}th embodiments described above. In FIG. 31, a reference character 3150 denotes a flying surface shape having the characteristics of the 15-17th embodiments and a reference character 3122 denotes the heating mechanism for lubricant vaporization. In other words, this head slider has the characteristics of the 15-17th embodiments and a center pad and the center pad, formed on the flying surface of the slider is bridged with pads having a surface one step lower than the highest surface of the slider flying surface to vaporize the lubricant attaching on the edge face of the slider trailing edge by the heating mechanism.

Referring to the preferred embodiments, this invention has now been described in detail. By forming a pad or pads on the area where the lubricant is apt to be accumulated, the lubricant attached on the head slider is constantly drawn off of the trailing edge before it grows to a mass. Thereby the effect of lubricant accumulation on the flying characteristics is eliminated. Further, the lubricant attached on the slider surface is put in an easy-to-spread and vaporize state. Thus, the possibility of the lubricant drop decreases and the flying stability of the head slider increases. In addition, the possibility that the lubricant attaches on the slider surface caused by surrounding the center pad with the step surface decreases.

Again, since the rail extending in the width direction to surround the negative pressure areas is lowered, the spacing between the rail and the medium increases and the lubricant on the medium is less likely to attach on the rail. Consequently, the lubricant is not accumulated in the vicinity of the trailing edge when it flows on the slider, so the lubricant drop phenomenon, the flying instability, the crash and the impediment to data writing/reading are curbed and stable flying characteristics in ultra-low flying is accomplished.

These head sliders are not considered to be limited with the numeric values stated in the embodiments above, but also include appropriate variations that do not impair their aims and advantages.

What is claimed is:

1. A head slider of a magnetic disk device having a recording medium, comprising:
a center pad formed on an air bearing surface in the vicinity of a center of a trailing edge of the slider; and
a trailing pad formed so as to bridge a trailing edge of the center pad and the trailing edge of the slider, formed lower than a highest surface of the center pad and higher than a lowest surface of the slider,
wherein the head slider does not have surfaces in the same height of the trailing edge pad on both sides of the center pad in a width direction.

2. The head slider according to claim 1, wherein the trailing edge pad has substantially the same height as the leading edge side of the center pad and is one step lower than the highest surface of the center pad.

3. The head slider according to claim 2, wherein the trailing edge pad is 0.1 μm lower than the highest surface of the center pad or lower.

4. The head slider according to claim 1, wherein the head slider has pads that are lower than the trailing edge pad in the vicinity of the trailing edge of the slider.

5. The head slider according to claim 1, wherein a corner of the trailing edge pad is rounded or chamfered.

6. The head slider according to claim 1, wherein a heating mechanism for flying height control is buried in the trailing edge of the slider.

7. The head slider according to claim 1, wherein a heating mechanism for lubricant vaporization is buried in the trailing edge of the slider.

8. The head slider according to claim 6, wherein the heating mechanism for flying height control is activated when after data reading/writing, when the head contacts the medium, after applying the certain amount of current, or after the slider has tracked the medium for a certain period of time.

9. The head slider according to claim 6, wherein a conductivity of a material making a portion between the heating mechanism and the edge face of the trailing edge of the slider is higher than that of alumina.

10. The head slider according to claim 1, wherein a groove is formed in a depth of 0.5-200 μm on the edge face of the trailing edge of the slider.

11. The head slider according to claim 1, wherein the groove stretches from the trailing edge pad to, at least, near ends of the slider in a width direction.

12. The head slider according to claim 10, characterized in that wherein the groove does not stretchextend to a flying phase of the trailing edge pad.

13. The head slider according to claim 10, wherein a heating mechanism for flying height control is buried in the trailing edge of the slider.

14. The head slider according to claim 1, wherein the edge face of the trailing edge of the slider is made of a material having a higher surface free energy than that of lubricant on the magnetic disk.

15. The head slider according to claim 1, wherein the edge face of the slider is made of a material having a higher surface free energy than that of alumina.

16. The head slider according the claim 1, wherein the edge face of the trailing edge of the slider is made of a carbon film or a metal film.

17. The head slider according to claim 10, wherein the groove is formed in a meander shape.

18. A head slider of a magnetic disk device, comprising:
a heating mechanism for flying height control buried in a trailing edge of the slider; and
a heat transfer plate buried in the slider, conducting heat generated by the heating mechanism to the edge face of the slider.

19. A head slider of a magnetic disk device, comprising:
a negative pressure area generating a negative pressure on an air bearing surface of the slider; and
one or a plurality of rails stretching in a width direction to surround the negative pressure area,
wherein, at least one rail is 0.1 μm lower than a highest surface or lower.

20. The head slider according to claim 19, wherein only a rail formed most inside to the negative pressure area is 0.1 μm lower than the highest surface or lower.
